(19) United States
(12) Patent Application Publication
(10) Pub. No.: US 2025/0341234 A1
(43) Pub. Date: Nov. 6, 2025

(54) BEARING DEVICE WITH INTEGRATED ELECTRIC INSULATION, IN PARTICULAR FOR AN ELECTRIC MACHINE OR MOTOR

(71) Applicant: AKTIEBOLAGET SKF, GOTEBORG (SE)

(72) Inventor: Mickael CHOLLET, Joué-Lès-Tours (FR)

(21) Appl. No.: 19/192,915

(22) Filed: Apr. 29, 2025

(30) Foreign Application Priority Data
May 6, 2024 (FR) 2404703

(51) Int. Cl. F16C 41/00; F16C 19/06

(52) U.S. Cl. CPC F16C 41/002; F16C 19/06; F16C 2380/26

(57) ABSTRACT

A bearing device includes a bearing having first and second mutually rotatable rings and a bushing having a first cylindrical surface, a second cylindrical surface radially spaced from a first cylindrical surface of the bushing, a first flange extending radially from a first end of the first cylindrical surface and a second flange extending radially from the second cylindrical surface. The first flange has a free edge having a first diameter and the second flange has a free edge having a second diameter less than the first diameter. An electrically insulating insert is overmolded between and connects the first cylindrical surface of the bushing and the second cylindrical surface of the second ring and is also overmolded on the first flange and the second flange.

### CROSS-REFERENCE

This application claims priority to French patent application no. 2404703 filed on May 6, 2024, the contents of which are fully incorporated herein by reference.

### TECHNOLOGICAL FIELD

The present disclosure is directed to the field of bearings used in particular in electric motors, electric machines and associated equipment, and more specifically to the field of electrically insulated bearing devices.

### BACKGROUND

In an electric machine or motor, at least one rolling bearing is mounted between the casing of the electric machine or motor and the rotary shaft in order to support this shaft. In operation, when the shaft is rotating, a difference in electric potential may arise between the shaft and the casing of the electric machine or motor, generating an electric current between the inner ring of the rolling bearing which is connected to the shaft, and the outer ring which is connected to the casing. The electric current passing through the components of the rolling bearing may damage these currents, in particular the rolling elements and the raceways formed in the inner and outer rings. The electric shocks may also cause vibrations.

To remedy these drawbacks, it is known to replace the rolling elements of the bearing that are made from the same steel as that of the inner and outer rings with rolling elements made of ceramic. This kind of bearing is generally referred to as a hybrid rolling bearing. However, such a hybrid rolling bearing is relatively expensive.

To remedy the abovementioned drawbacks, it is also known to equip the outer ring of the rolling bearing with an insulating sleeve provided with a bushing and with an insulating insert made of an electrically insulating material and interposed radially between the outer ring and the bushing. In order to fasten the insulating insert to the outer ring and to the bushing without an additional element or particular machining of the outer ring, it is possible to overmold the insulating insert. However, with such a solution, relative detachment of the insulating insert and the bushing may arise during operation.

### SUMMARY

The present disclosure therefore aims to remedy the abovementioned drawbacks by providing a bearing device of simple and economical design.

The disclosure relates to a bearing device comprising a bearing provided with a first ring and a second ring which are able to rotate with respect to one another. The device also comprises an insulating sleeve mounted on the second ring of the bearing. The insulating sleeve is provided with a one-piece bushing and with an insulating insert interposed radially between the second ring of the bearing and the bushing. The insulating insert is made of an electrically insulating material.

The expression “one-piece bushing” means that the bushing is produced integrally. The bushing may be made as a single piece, or alternatively as a plurality of pieces that fastened together. In other words, the bushing forms a single unitary whole. The bushing comprises an outer surface and an inner surface on the opposite side from the outer surface, which delimit the radial thickness of the bushing.

The insulating insert is overmolded on the second ring of the bearing and at least on one of the outer and inner surfaces of the bushing.

According to a general feature, the bushing comprises an axial portion delimiting the surface of the bushing on which the insulating insert is overmolded, and first and second flanges continuing the axial portion radially towards the second ring.

According to another general feature, the insulating insert is also overmolded on an internal face of each of the first and second flanges.

According to another general feature, the radial dimension of the second flange is greater than the radial dimension of the first flange of the bushing.

Producing the bushing with flanges makes it possible to achieve a firm connection with the insulating insert. The risk of relative movements between the insulating insert and the bushing in the axial direction is avoided in particular under variations in temperature.

The expression “axial direction” means the direction parallel to the axis of the bearing device.

Furthermore, providing flanges that have different radial dimensions makes it possible to have a bushing exhibiting good mechanical strength on the large flange side while easily allowing, on the small flange side, the axial mounting of the second ring, or of the bearing as a whole, radially on the inside of the bushing or radially on the outside thereof.

This results in a bearing device with integrated electric insulation that is economical compared with conventional hybrid rolling bearings and easy to manufacture.

Preferably, the second flange of the bushing extends radially beyond a radially outer surface or inner surface of the second ring on which the insulating insert is overmolded.

With such a provision, the part of the insulating insert that is situated axially between the second ring and this second flange of the bushing is not subject to shear stresses when significant axial loads are applied to the device mounted inside the casing of the electric machine or motor associated with this second flange bearing against a shoulder of the casing. This is because, in this case, compressive stresses are applied to this part of the insulating insert. This increases the reliability of the device.

Also preferably, the first flange of the bushing is radially set back from the outer surface or inner surface of the second ring. Thus, the axial mounting of the second ring, or of the bearing as a whole, relative to the bushing can be carried out via a simple axial push.

A first groove may be formed in a first frontal face of the second ring and a second groove may be formed in a second frontal face of the second ring, the first and second grooves axially delimiting the outer surface or inner surface of the second ring. The first flange of the bushing may be radially at a distance from the first groove and the second flange may extend partially in the second groove. The insulating insert may be provided with two frontal faces that delimit its axial length.

According to a first design, at least one of the first and second flanges of the bushing is axially flush with one of the frontal surfaces of the insulating insert. According to a second design, each of the first and second flanges of the bushing is axially flush with one of the frontal surfaces of the insulating insert. Alternatively, one of the flanges or each flange of the bushing may be offset axially towards the inside or towards the outside with respect to the associated frontal surface of the insulating insert.

According to a particular design, the surface of the bushing is provided with at least one groove which extends in the circumferential direction and within which there extends an attachment rib of the insulating insert of complementary shape.

Thus, the axial attachment of the insulating insert to the bushing is further improved.

The expression “circumferential direction” means the direction which is perpendicular both to the axial direction and to a radius of the bearing device, in other words tangent to a circle the center of which is on the axis of the bearing device.

If the insulating insert is made of synthetic material or elastomer material, this makes the device less sensitive to variations in temperature.

In one particular embodiment, the bushing is made of metal material. Thus bushing can thus be machined easily to a predetermined radial tolerance. Advantageously, the bushing is obtained from a sheet metal blank by cutting, pressing and roll bending.

In one embodiment, the insulating insert covers the entire radially outer or radially inner surface of the bushing. In this case, the insulating insert entirely covers the surface of the bushing in the axial direction and in the circumferential direction.

In one embodiment, a bearing device comprises a bearing including a first ring and a second ring configured to rotate relative to each other, the second ring having a first cylindrical surface and a second cylindrical surface radially spaced from the first cylindrical surface. The device also includes a bushing having an axial length, a first cylindrical surface, a second cylindrical surface radially spaced from the first cylindrical surface of the bushing, a first flange extending radially from a first end of the first cylindrical surface and a second flange extending radially from the second cylindrical surface. An electrically insulating insert is overmolded between and connects the first cylindrical surface of the bushing and the second cylindrical surface of the second ring. The first flange has a free edge having a first diameter and the second flange has a free edge having a second diameter less than the first diameter, and the insulating insert is overmolded on the first flange and the second flange. Furthermore, the second ring may be a radially outer ring and the second cylindrical surface may be a radially outermost surface of the second ring. In that case, the second diameter of the free edge of the second flange is less than a diameter of the radially outermost surface of the second ring. In addition, the first diameter of the free edge of the first flange may also be greater than a diameter of the radially outermost surface of the second ring.

According to a first design, the bushing delimits the outer surface of the device. In this case, the second ring is the outer ring of the bearing. According to a second alternative design, the bushing delimits the inner surface of the device. In this case, the second ring is the inner ring of the bearing.

In one particular embodiment, the bearing comprises at least one row of rolling elements disposed between the raceways of the first and second rings. The rolling elements may be made of metal material.

The disclosure also relates to an electric motor comprising a casing, a shaft and at least one bearing device as defined above and mounted radially between the casing and the shaft.

### BRIEF DESCRIPTION OF THE DRAWINGS

The present invention will be understood better from studying the detailed described of embodiments, which are given by way of entirely non-limiting example and are illustrated in the appended drawings, in which:

FIG. 1 an axial sectional view of a portion of a bearing device according to one exemplary embodiment of the disclosure.

FIG. 2 is a partial exploded perspective view of the bearing device of FIG. 1 without the insulating insert.

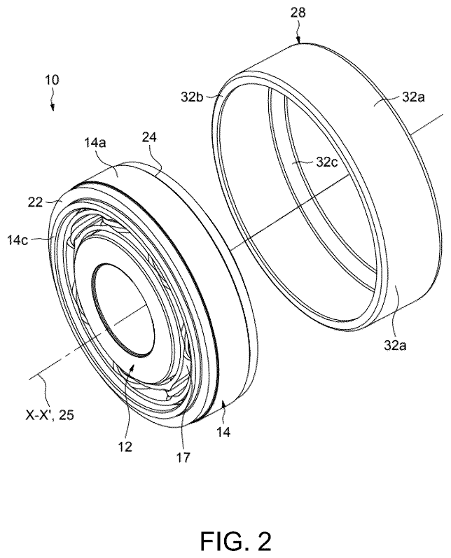

FIG. 3 is an axial sectional view of a bearing device according to another exemplary embodiment of the disclosure.

### DETAILED DESCRIPTION

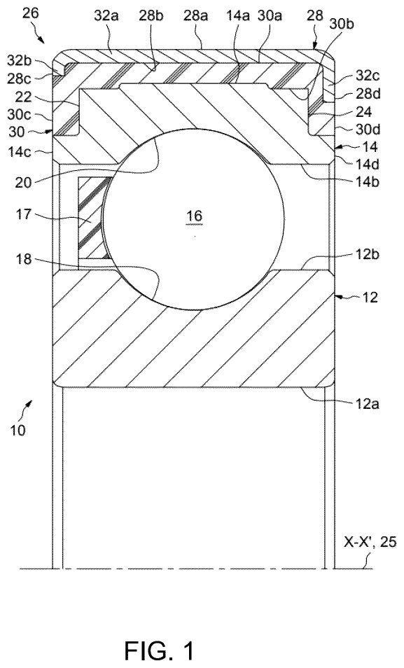

The bearing device illustrated in FIG. 1 comprises a bearing 10 having a first ring 12 and a second ring 14 which are configured to rotate with respect to one another about the axis X-X′ of the bearing. In the exemplary embodiment illustrated, the first ring 12 is the inner ring of the bearing and the second ring 14 is the outer ring. The bearing device has been designed so as not to conduct electric currents. The bearing device has integrated electric insulation.

The inner ring 12 and outer ring 14 of the bearing are concentric and extend axially along the axis X-X′ of the bearing. The inner ring 12 and outer ring 14 are made of steel. The rings are of the solid type.

In the exemplary embodiment illustrated, the bearing 10 also comprises a row of rolling elements 16, in this case balls, that are interposed radially between the inner ring 12 and outer ring 14. The rolling elements 16 are made of steel. The bearing 10 also comprises a cage 17 for maintaining the regular circumferential spacing of the rolling elements 16. The bearing 10 may also be equipped with seals or flange gaskets.

The inner ring 12 has a cylindrical bore 12a, a cylindrical axially extending radial outer surface 12b radially on the opposite side from the bore, and two opposite radially extending frontal faces (not referenced) that axially delimit the bore and the outer surface. The bore 12a and the outer surface 12b delimit the radial thickness of the inner ring 12. The bore 12a forms the inner surface of the inner ring. The inner ring 12 also has an inner raceway 18 for the rolling elements 16, which is formed on the outer surface 12b. The raceway 18 is directed radially towards the outside.

The outer ring 14 has a cylindrical axially extending radial outer surface 14a, a cylindrical bore 14b radially on the opposite side from the outer surface 14a, and two radially extending axially spaced frontal faces 14c, 14d that axially delimit the bore. The outer surface 14a and the bore 14b delimit the radial thickness of the outer ring 14. In the exemplary embodiment illustrated, the outer surface 14a of the ring has two different diameters. Alternatively, the outer surface 14a could have a single diameter. The outer ring 14 also has an outer raceway 20 for the rolling elements 16, which is formed on the bore 14b. The raceway 20 is directed radially towards the inside.

In the exemplary embodiment illustrated, a first groove 22 is formed in the frontal face 14c of the outer ring. The groove 22 is oriented axially towards the outside of the outer ring. The groove 22 has a bottom which is offset axially towards the inside of the ring with respect to the frontal face 14c. The bottom of the groove 22 forms a shoulder. The bottom of the groove 22 extends radially in this case for reasons of ease of manufacture. The groove 22 is annular in this case.

Similarly, a second groove 24 is formed in the frontal face 14d of the outer ring. The groove 24 is oriented axially towards the outside of the outer ring. The groove 24 has a bottom which is offset axially towards the inside of the ring with respect to the frontal face 14d. The bottom of the groove 24 forms a shoulder. The bottom of the groove 24 extends radially in this case. The groove 24 is annular in this case. The grooves 22, 24 are mutually symmetric with respect to a radial midplane of the outer ring. The grooves 22, 24 axially delimit the outer surface 14a.

The bearing device also comprises an electrically insulating sleeve 26 mounted on the outer ring 14. The insulating sleeve 26 is mounted on the outer surface 14a of the outer ring 14. The insulating sleeve 26 is secured to the outer ring 14. The insulating sleeve 26 comprises a bushing 28 and an electrically insulating insert 30 interposed radially between the outer ring 14 and the bushing 28. The insulating insert 30 is overmolded on the outer ring 14 and on the bushing 28.

The bushing 28 has an annular shape. The bushing 28 is formed in one piece. The bushing 28 is formed in this case from a single piece. Preferably, the bushing 28 is made of steel. The bushing 28 may advantageously be obtained from a sheet metal blank by cutting, pressing and roll bending. Alternatively, the bushing 28 may be obtained from a tube or from a forged and/or rolled blank, or by sintering and stamping.

The bushing 32 comprises an axially extending radially outer portion 32a, and first and second annular radially extending flanges 32b, 32c that each extend radially inward from the axial portion radially. Each flange 32b, 32c extends radially. Each flange 32b, 32c extends from an axial end of the axial portion 32a and has a free end radially spaced from the axial portion 32a. In the exemplary embodiment illustrated, the flanges 32b, 32c are annular. Alternatively, at least one of the flanges 32b, 32c could be in the form of sectors that are spaced apart from one another in the circumferential direction. The inner diameter of the flange 32b is greater than the inner diameter of the flange 32c.

The bushing 28 comprises a cylindrical axially extending radially outer surface 28a, and a cylindrical inner surface 28b which is radially on the opposite side from the outer surface 28a and the axis 25 of which is coaxial with the axis X-X′. The cylindrical inner surface 28b forms the inner surface of the bushing 28. The axial portion 32a of the bushing delimits the axial end of the bushing 28 and is located at the axial end of the cylindrical inner surface 28a. The outer surface 28a and the cylindrical inner surface 28b delimit the radial thickness of the bushing 28. The outer surface 28a of the bushing forms the outer surface of the bearing device 10. In other words, the outer surface 28a defines the outside diameter of the bearing device 10.

The bushing 28 also comprises two opposite frontal faces 28c, 28d that axially delimit the outer surface 28a. The frontal faces 28c, 28d delimit the axial length of the bushing. The frontal face 28c is located on the flange 32b, and the frontal face 28d is located on the flange 32c. More specifically, the frontal face 28c is the outer face of the flange 32b, and the frontal face 28d is the outer face of the flange 32c.

In the exemplary embodiment illustrated, the frontal faces 28c, 28d of the bushing are respectively coplanar with the frontal faces 14c, 14d of the outer ring. Alternatively, it could be possible to provide other arrangements. For example, the bushing 28 could have a smaller, or larger, axial dimension and be axially set back from the faces 14c, 14d of the outer ring, or protrude from the faces.

The radial dimension of the flange 32c of the bushing is greater than the radial dimension of the flange 32b. The flanges 32b, 32c of the bushing are asymmetric with respect to a radial midplane of the device.

In the exemplary embodiment illustrated, the flange 32b is radially set back (spaced from) with respect to the outer surface 14a of the outer ring. In other words, the free end of the flange 32b is offset radially towards the outside with respect to the outer surface 14a. The flange 32b is radially set back from the groove 22 of the outer ring.

In the exemplary embodiment illustrated, the flange 32c of the bushing extends radially beyond the outer surface 14a of the outer ring, i.e. protrudes radially towards the inside with respect to the outer surface 14a. In other words, the free end of the flange 32c is offset radially towards the inside with respect to the outer surface 14a of the outer ring. In other words, the inner diameter of the flange 32c is less than the outer diameter of the outer ring 14. The flange 32c extends partially in the groove 24 in the outer ring. The flanges 32b, 32c are at a distance from the outer ring 14.

The insulating insert 30 is made of electrically insulating material. The insulating insert 30 may, for example, be made of synthetic material, such as PEEK or PA46, or be made of an elastomer material, for example of rubber.

The insulating insert 30 is interposed radially between the outer surface 14a of the outer ring and the bore 28b in the bushing. The insulating insert 30 covers the outer surface 14a of the outer ring. The insulating insert 30 in this case entirely covers the outer surface 14a with regard to the axial and circumferential directions. The insulating insert 30 also covers the grooves 22, 24 in the outer ring.

The insulating insert 30 also covers the cylindrical inner surface 28b in the bushing. The insulating insert 30 in this case also entirely covers the cylindrical inner surface 28b with regard to the axial and circumferential directions. The insulating insert 30 covers the cylindrical inner surface in the axial portion 32a of the bushing.

The insulating insert 30 also covers the internal face of each flange 32b, 32c of the bushing. The internal face and the external face axially on the opposite side from the internal face of each flange 32b and 32c delimit the axial thickness of the flange. For each flange 32b and 32c, the internal face is oriented axially towards the inside of the device, and the external face is oriented axially towards the outside of the device. The insulating insert 30 also covers the free end of each flange 32b, 32c of the bushing.

The insulating insert 30 has an annular shape. The insulating insert 30 extends axially. The insulating insert 30 comprises a cylindrical axial outer surface 30a, a cylindrical inner surface 30b radially on the opposite side from the outer surface 30a, and two radially opposite frontal faces 30c, 30d that axially delimit the inner surface and the outer surface. The radial frontal faces 30c, 30d axially delimit the insulating insert 30. The outer surface 30a and the inner surface 30b delimit the radial thickness of the insulating insert 30. The outer surface 30a is in radial contact with the inner surface 28b in the bushing. The outer surface 30a is also in radial contact with the free end of each flange 32b, 32c of the bushing. The outer surface 30a has a stepped shape. The inner surface 30b is in radial contact with the outer surface 14a of the outer ring and with the grooves 22, 24. The inner surface 30b has a stepped shape.

In the exemplary embodiment illustrated, the faces 14c, 30c, 28c and 14d, 30d, 28d of the outer ring, of the insulating insert and of the bushing are respectively coplanar.

Alternatively, it is possible to provide other arrangements. For example, the insulating insert 30 could have a smaller axial dimension and be axially set back from the faces 14c, 14d of the outer ring. Alternatively, the insulating insert 30 could have a larger axial dimension and protrude axially from the faces 14c, 14d of the outer ring. In this case, the insulating insert 30 may at least partially cover these faces 14c, 14d. In a variant, the insulating insert 30 could at least partially cover the faces 28c, 29d of the bushing.

In another alternative or in combination, the bushing 28 could protrude axially from the insulating insert 30 with respect to the faces 30c and 30d, or be axially set back from these faces.

In order to manufacture the bearing device, the following method is followed.

In a first step, the bearing 10 and the bushing 28 are mounted inside a mold which is provided for the overmolding of the insulating insert 30. In this position mounted inside the mold, the bushing 28 is radially at a distance from the outer ring 14 of the bearing. The bearing 10 was previously introduced axially into the interior of the bushing 28 towards the small flange 32b.

Next, during a following second step, the insulating insert 30 is overmolded both on the outer ring 14 of the bearing and on the bushing 28.

Lastly, the bearing device, which is in the form of a unitary whole, is removed from the mold.

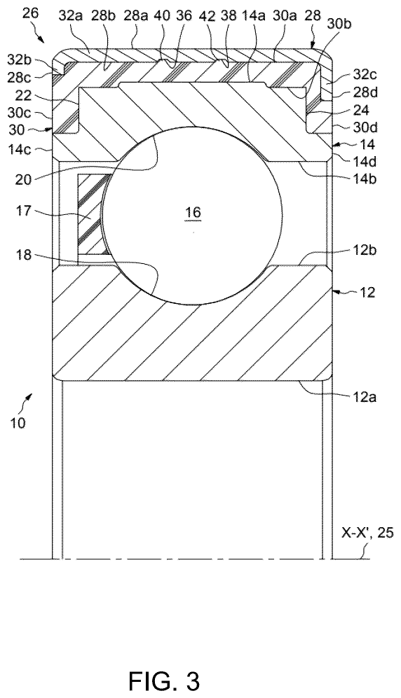

The exemplary embodiment illustrated in FIG. 3, in which the identical elements are identified by the same references, differs from the previous example in that the bore in the axial portion 32a of the bushing is provided with two grooves 36, 38 that are axially spaced apart and extend circumferentially about the axis 25 of the bore in the bushing. Each groove 36, 38 is oriented radially towards the outer ring 14, i.e. radially inward.

In the exemplary embodiment illustrated, each groove 36, 38 is annular. Alternatively, at least one of the two grooves 36, 38 could not extend through 360°, or be formed by a succession of turns that extend circumferentially and are spaced apart from one another in the circumferential direction.

Each groove 36, 38 is delimited in the axial direction by two lateral flanks that face one another, have a straight profile in axial section and are connected together by an axial bottom. Alternatively, it is possible to provide other shapes, for example groove that in this case have, in cross section, the shape of a circular arc oriented towards the inside. In another variant, the bushing 28 may also not have the groove 36, 38.

The insulating insert 30 also comprises two ribs 40, 42 that extend radially towards the outside from the outer surface 30a and are each housed inside one of the grooves 36, 38 in the bushing. The rib 40, 42 has a shape complementary to that of the associated groove 36, 38. Each rib 40, 42 protrudes from the outer surface 30a of the insulating insert. Each rib 40, 42 is formed on the outer surface 30a during the overmolding of the insulating insert 30.

In the exemplary embodiments illustrated, the first ring 12 of the bearing is the inner ring and the second ring 14, on which the insulating insert 30 is overmolded, is the outer ring.

Alternatively, it is possible to provide an opposite disposition, in which the second ring 14, on which the insulating insert 30 is overmolded, is the inner ring. In this case, the insulating sleeve is situated in the bore 12a in the inner ring. The insulating insert is then interposed radially between the bore 12a in the inner ring and the outer surface of the bushing. The insulating insert is overmolded on the inner ring and at least on the outer surface of the bushing. The bore in the bushing delimits the bore in the bearing device. In this case, the free ends of the flanges 32b, 32c would face radially outwardly.

In the exemplary embodiments described, the bearing of the device is provided with a single row of rolling elements. In a variant, the bearing may be provided with several rows of rolling elements. Furthermore, the rolling bearing may comprise other types of rolling elements than balls, for example rollers. In another variant, the bearing may be a plain bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length, a first cylindrical surface, a second cylindrical surface radially spaced from the first cylindrical surface of the bushing, a first flange extending radially from a first end of the first cylindrical surface and a second flange extending radially from the second cylindrical surface, and
an electrically insulating insert overmolded between and connecting the first cylindrical surface of the bushing and the second cylindrical surface of the second ring,
wherein the first flange has a free edge having a first diameter and the second flange has a free edge having a second diameter less than the first diameter, and
wherein the insulating insert is overmolded on the first flange and the second flange.

2. The device according to claim 1,
wherein the second ring is a radially outer ring and the second cylindrical surface is a radially outermost surface of the second ring, and
wherein the second diameter of the free edge of the second flange is less than a diameter of the radially outermost surface of the second ring.

3. The device according to claim 2,
wherein the first diameter of the free edge of the first flange is greater than a diameter of the radially outermost surface of the second ring.

4. The device according to claim 1,
wherein the second ring is a radially inner ring and the second cylindrical surface is a radially innermost surface of the inner ring, and
wherein the second diameter of the free edge of the second flange is greater than a diameter of the radially innermost surface of the second ring.

5. The device according to claim 4,
wherein the first diameter of the first edge of the first flange is less than a diameter of the radially innermost surface of the second ring.

6. The device according to claim 3, wherein the first flange of the bushing is radially spaced from the second cylindrical surface of the second ring.

7. The device according to claim 3,
wherein a first groove is formed in a first frontal face of the second ring and a second groove is formed in a second frontal face of the second ring, the first and second grooves axially delimiting the second cylindrical surface of the second ring, the first flange of the bushing being radially spaced from the first groove and the second flange extending partially into the second groove.

8. The device according to any claim 7,
wherein the insulating insert comprises two frontal faces that delimit an axial length of the insert, and
wherein the first flange and/or the second flange is axially flush with one of the two frontal faces of the insulating insert.

9. The device according to claim 8,
wherein the second cylindrical surface of the bushing includes a circumferentially extending groove, and
wherein a circumferential rib of the insulating insert extends into the groove.

10. The device according to claim 9,
wherein the groove extends 360°.

11. The device according to claim 10,
wherein the bushing is made of metal.

12. The device according to claim 10,
wherein the bushing is formed from a strip of sheet metal and the flanges are bent from edges of the strip.

13. The device according to claim 12,
wherein the insulating insert is made of elastomeric material.

14. An electric motor comprising:
a casing,
a shaft, and a bearing device according to claim 1 mounted radially between the casing and the shaft.

15. An electric motor comprising:
a casing,
a shaft, and a bearing device according to claim 3 mounted radially between the casing and the shaft.
